(19) United States
(12) Patent Application Publication
(10) Pub. No.: US 2009/0256036 A1
(43) Pub. Date: Oct. 15, 2009

(54) BLINDS AND COMPONENTS THEREOF

(75) Inventor: Neil Wilson, Glasgow (GB)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Turnils (UK) Limited, Renfrew, SC (GB)

(21) Appl. No.: 12/375,790

(22) PCT Filed: Aug. 2, 2007
(86) PCT No.: PCT/GB07/02941

§ 371 Date: Jan. 30, 2009

(30) Foreign Application Priority Data
Aug. 4, 2006 (GB) 0615518.8
Feb. 1, 2007 (GB) 0701931.8

(51) Int. Cl. E06B 9/323; A47B 96/06

(52) U.S. Cl. 248/201; 160/368.1; 248/226.11

(57) ABSTRACT

A system for mounting a blind (100) at a glazed aperture, the blind including a head assembly (124) and a slave bar (108) between which extends one or more blind panels (102), the glazed aperture comprising a frame (10), a glazing pane (20a) retained in the frame and a flexible or resilient bead (22) disposed between the glazing pane and the frame which bead bears against the glazing pane. The system comprises mounting means (38, 40) for the head assembly, to mount the head assembly at or near the top of the glazed aperture; first and second mounting brackets (78, 80; 178, 180), each comprising a first portion having at least a first laterally extending planar finger (82) configured to slide in use between the bead (22) and the glazing pane (20a), and a second portion (84) defining an attachment formation (86) which extends substantially orthogonally with respect to the plane of the glazing pane. A support cord (106) is adapted for connection to and extending from one attachment formation, through one end of said slave bar into the head assembly, through a tension mechanism (110), and down through the other end of said slave bar to said other attachment formation. Indeed, the invention provides a bottom anchor (178, 180) for a blind, said anchor comprising such first and second mounting brackets and means to connect a support cord for the blind.

The present invention relates to blinds (or shades) such as roller blinds, vertical blinds, Roman blinds and, in particular, to Venetian blinds and pleated blinds for use primarily at glazed windows, and to apparatus by which such blinds are mounted in their location of use. In particular, the present invention relates to blinds comprising a head rail and a bottom rail between which cords are tensioned to support a blind between the rails. The invention also relates to components used in the manufacture of such blinds or apparatus. The blinds and apparatus of the invention are applicable primarily to apertures glazed with a transparent, translucent, coloured or colourless glazing pane or panel, but may also be used with other suitable glazing materials such as transparent, translucent, coloured or colourless plastic sheets.

Unless the context requires otherwise, the terms “glazing”, “glazing pane”, “glazing panel” “glazed” and “glazing” as used herein are intended to include or encompass glazing and/or other suitable glazing materials. The term “glazed window” refers primarily to external windows of buildings such as houses and offices and also includes conservatories. Further, unless the context requires otherwise, “glazed window” as used herein encompasses other glazed apertures such as glazed doors, glazed internal partitions (such as in offices) and other like locations

### BACKGROUND

Most blinds comprise a panel or a group of panels of shading material the configuration of which can be changed by the user to shade or expose the window. Thus a roller blind comprises a web of fabric which in the shading configuration lies approximately parallel to the window and in the exposing condition is wound around a rigid roller or the like conventionally arranged near the top of the window. Vertical blinds include a plurality of panels or slats which hang vertically from a head rail conventionally mounted near the top of the window. Mechanisms are provided, primarily in the head rail, by which the panels can be rotated about their longitudinal axes and by which the panels can be moved along the head rail laterally with respect to the window, by both of which means the degree of shading of the window is adjusted.

Venetian blinds, which are also known as slatted blinds, are also well known and conventionally comprise an upper supporting structure in the form of a head rail from which depend two or more spaced apart ladders. The ladders comprise a pair of longitudinal cords or threads aligned in use substantially parallel to the window with a plurality of lateral threads inter-connecting the longitudinal cords at regular intervals. The lateral threads support respective laths or slats which form the shading part of the blind. The slats may rest on the lateral threads without any attachment, or some or all of the slats may be directly connected to respective lateral threads.

Mechanisms are conventionally provided by which the blind can be raised and lowered so that it can adopt configurations in which the window is wholly shaded, partially shaded or unshaded. Such mechanisms will normally include at least one lift cord which may pass through holes defined in the slats of the blind or may, for example, run behind the slats. Also, mechanisms are provided by which the slats can be tilted or inclined out of a nominally horizontal alignment into alignments tending towards the vertical, thereby to vary the degree of shading provided by the blind. Tilting is conventionally effected by adjusting the configurations of the longitudinal cords of the ladders.

Pleated blinds are also well known and comprise a supporting structure in the form of a master rail. The master rail is often located in use at an upper portion of the glazed aperture, but this is not necessarily so. For example, the master rail can, in some circumstances be mounted at the side or lower part of the glazed aperture. A web of fabric which is used to shade the window is supported by the master rail. The fabric is constructed so that it includes a number of concertina-like folds (“pleats”), whereby the web can be adjusted from a compact configuration in which the window is exposed to an extended configuration where the window is shaded. Support cords pass through or behind the folded web and normally are attached to a moveable bar which is raised and lowered as the web is adjusted between its configurations.

Thus each type of blind normally includes a substantially rigid element, member or assembly such as a master rail or head rail from which the shading portion of the blind is, directly or indirectly, supported. In the case of a roller blind, the roller or tube about which the blind is operationally wound, together with mounting brackets at either end of the roller, forms such a substantially rigid assembly. In the case of Venetian, vertical and pleated blinds the head rail or master rail forms such a substantially rigid element. The element, member or assembly is hereinafter referred to as the “head assembly” but this term should be understood, unless the context requires otherwise, to include the possibility that the rail could be at the lower side of a window, with the blind panel(s) being raised in order to deploy the blind in its shading position. Typically, however, the element, member or assembly is at the upper side of the window, with the blind panels being deployed, usually at least to some extent, with the aid of gravity. The blind conventionally is mounted at a window or other location of use by securing the head assembly directly or indirectly to the window frame or surrounding portion of wall, lintel etc by use of screws or the like. Although this will normally provide a secure attachment, it is often time consuming and inconvenient. In addition, it can be disadvantageous, for example in that holes or marks are left in the frame when the blind is removed. This is especially so where the blind is mounted to a plastic (typically uPVC) frame where the holes cannot be readily filled or otherwise repaired.

In order to overcome this and other deficiencies, it has been proposed to mount a Venetian, pleated, roller, Roman or other types of blind directly to the window frame without the use of screw fixings or the like. One proposed solution employs metal brackets which include a portion which is forced between the rubber bead of the window frame and the window glazing. A pre-assembled rectangular frame which carries the blind is then mounted on the brackets by means of a push-fit arrangement. This arrangement is disadvantageous in a number of respects. Significantly, because the depth of the window frame between the surface of the glazing and the inner face of the frame varies between different window designs, and because the metal brackets are available in only a limited range of sizes, a significant and aesthetically undesirable gap is left between the blind frame and the window frame. Also, forces due to the inherent weight of the blind and also operation forces of the blind (which principally occur when raising or lowering the blind) are transferred via the frame to the metal brackets and thence to the glazing. This potentially transfers stresses to the glazing very locally through the edges of the metal brackets. Further, the size of the frame is significant in reducing the effective glazed area of the window. For example, for a window with a nominal 1 m×1 m glazed area, the frame reduces the visible glazed area to 0.95 m×0.95 m.

Our copending United Kingdom patent application number 0615518.8 seeks to provide a means of attachment of a blind to a window frame, principally, but not exclusively, a uPVC window frame, which does not employ permanent fixings (such as screw fixings) and which avoids the disadvantages outlined above.

It is noted that the attachment of blinds to windows using brackets having a portion which slides between a window bead and the window glazing is, in general terms known, primarily for attaching internal blinds to the windows of automobiles.

According to a first aspect of that invention there is provided a system for mounting a blind including a head assembly at a glazed aperture, the glazed aperture comprising a frame, a glazing pane retained in the frame and a flexible or resilient bead disposed between the glazing pane and the frame which bead bears against the glazing pane; the system comprising:
first and second mounting components each including
   a base portion having a base surface configured to rest in use against the glazing pane,
   a post portion configured to extend in use approximately orthogonally with respect to the plane of the glazing pane; and
   a mounting bracket portion having at least one laterally extending planar finger configured to slide in use between the bead and the glazing pane; and
first and second connecting components configured operatively to attach the blind head assembly to the respective post formations.

According to a second embodiment of the invention disclosed in GB0615518.8 there is provided a blind assembly mounted at a glazed aperture, the glazed aperture comprising a frame, a glazing pane retained in the frame and a flexible or resilient bead disposed between the glazing pane and the frame which bead bears against the glazing pane; the blind assembly comprising:
a blind head assembly from which a shade portion of the blind depends;
first and second mounting components each including:
   a base portion having a base surface resting against the glazing pane,
   a post portion extending approximately orthogonally with respect to the plane of the glazing pane; and
   a mounting bracket portion having at least one laterally extending planar finger disposed between the bead and the glazing pane; and
first and second connecting components by means of which the blind head assembly is attached to the respective post formations.

According to a third aspect of the invention disclosed in GB0615518.8 there is provided a method of mounting a blind including a head assembly at a glazed aperture, the glazed aperture comprising a frame, a glazing pane retained in the frame and a flexible or resilient bead disposed between the glazing pane and the frame which bead bears against the glazing pane; the method including the steps of:
providing first and second mounting formations each including a base portion having a base surface and a post portion configured to extend in use approximately orthogonally with respect to the plane of the glazing pane;
providing first and second mounting brackets each comprising a first portion including attachment means and a second portion having at least one laterally extending finger; and providing first and second connecting components attaching the respective mounting formations to the mounting brackets, placing the base surface of the base portions against the glazing pane and sliding the fingers between the glazing pane and the bead,
attaching the connecting components to respective side parts of the head assembly and mounting the respective connecting components on the post portions of the mounting formations.

In some blinds, (invariably in pleated blinds and occasionally in slatted blinds—especially in cases where the slatted blinds are not vertically arranged, for example as in roof windows), the blind is supported by tensioned support cords that extend on either side of the blind panel and stretch between the head rail and a bottom rail or other fixed support. A slave bar is generally provided at the bottom of the blind panel or panels and it slides on the cords, generally through a friction arrangement that holds the slave bar in any position it is left in. The blind panel or panels are supported between the slave bar and the head rail or master rail. Adjustment cords may be provided to raise or lower the slave bar, although in this event the friction arrangement may not be required, the blind instead employing gravity to pull the slave bar and blind panel(s) into a lower, shaded position of the blind, and the adjustment cords being used to raise the blind and hold the blind in an intermediate, or raised, unshading, position.

Generally, there is just one support cord that extends between the head rail and bottom support or lower rail on each side of the blind, the cord transitioning through the head rail from one end thereof to the other, and a spring being provided to tension the cord so that it has equal tension on each side of the blind. However, with wider blinds, more support cords may be provided between the end cords. Indeed, generally the cords will be in pairs and the outside cords may be paired with intermediate cords, rather than with each other. Hitherto the lower supports for the support cord or cords have needed separate fixing to the window frame at its bottom, generally requiring a screw fixing, which is a disadvantage, particularly with uPVC windows. Since the precise location of the lower fixing is generally not known, not only must separate tension adjustment mechanisms be provided to enable the tension of the support cords to be set during installation, but also this procedure must be carried out during the installation of the blind.

The support cords may cross through the lower slave bar in a figure-8 arrangement in which the lower bar forms the middle cross of the 8, the top cross is inside the head rail and the bottom either does not exist or is in a fixed, lower rail of the blind. The cross over enables the lower bar to be positioned at any vertical position with the blind fully closed, fully open or any intermediate position. The friction arrangement is provided in the lower bar to restrict movement of the cords through the bar so that the lower bar does not fall under its own weight. Indeed, for this reason the tension of the cords is often important, along with the equality of the tension on either side of the blind. This equally applies where multiple cords are employed. Although a spring is generally provided to apply the tension to the cord, in fact, the cord may have sufficient resilience on its own. Alternatively, other tensioning arrangements may be provided. The spring, when present, need not necessarily be located in the head rail, but could be in the slave bar, for example.

It is an object of the present invention to provide a blind system in which the use of separate fixing screws for the lower support can be avoided. A preferred arrangement also ensures that support cord tension can be preset in the factory.

In accordance with the present invention, there is provided a system for mounting a blind at a glazed aperture, the blind including a head assembly and a slave bar between which extends one or more blind panels, the glazed aperture comprising a frame, a glazing pane retained in the frame and a flexible or resilient bead disposed between the glazing pane and the frame which bead bears against the glazing pane; the system comprising:
mounting means for the head assembly, to mount the head assembly at or near the top of the glazed aperture;
first and second mounting brackets, each comprising a first portion having at least a first laterally extending planar finger configured to slide in use between the bead and the glazing pane, and a second portion defining an attachment formation which extends substantially orthogonally with respect to the plane of the glazing pane, and
a support cord adapted for connection to and extending from one attachment formation through one end of said slave bar into the head assembly and down through the other end of said slave bar to said other attachment formation.

Preferably, a tension mechanism tensions the cord. Preferably, said tension mechanism is in said head assembly.

Preferably said mounting bracket second portions each include a second co-planar finger arranged to extend orthogonally with respect to the first finger and configured to slide in use between the bead and the glazing pane at adjacent sides of the frame.

Preferably, the blind assembly further comprises a support clip mounted on the attachment formation, said cord being connected to said support clip. Preferably, said support clip is a sliding fit on said attachment formation in a direction orthogonal to said pane and includes means to secure the support clip on said attachment formation. Preferably, said securing means comprises a tab on one of the attachment formation and the support clip and a corresponding detent in the other of the attachment formation and the support clip, said tab snapping into said detent when the support clip is fully engaged with the attachment formation. However, any suitable securing means will be acceptable, even a screw fixing, for example, since the screw will in this event only screw into the support clip, after transitioning through the attachment formation. Preferably, said full engagement includes seating of a flange of the support clip against the pane and masking said mounting bracket.

Preferably, said cord is connected to said support clip at a location spaced at a distance from said pane so that tension in the cord causes a moment on said bracket resisted by said bead.

Preferably, first and second longitudinally extensive side members are configured for mounting at the sides of the glazed window to extend from proximate the head assembly to proximate the mounting brackets.

Preferably, lower end portions of the side members engage the respective mounting brackets, such as by one of the mounting bracket or the side member including a slot into which the other of the mounting bracket or the side member is received. Thus, preferably the lower parts of the side members and the mounting brackets respectively include operatively co-operating engagement formations.

Preferably, the tension in said cord when the system is installed in the glazed aperture is set remotely, prior to installation of the blind, wherein the length of said cord is determined by the length of said side members which themselves determine the separation of said attachment formation from said head assembly.

Preferably, an adjustable jig is provided whose dimensions are adjustable to correspond with said glazed aperture, whereby the blind may be fitted and the tension in said cord set prior to installation of the blind in said glazed aperture.

Preferably, said cord is relatively inextensible and said tension mechanism comprises a spring, the tension in the spring being determined by the length of the cord. Preferably, said tension mechanism is adjustable and is employed to set the tension in the cord. Said adjustment mechanism may comprise an extender, whereby the path length of the cord is adjustable to alter the tension of the cord. The extender may be in the head assembly. Alternatively, it, and the spring, could be located in the slave bar.

In the event that multiple support cords are provided, an intermediate support cord extends between end support cords disposed at each side of the blind, said intermediate cord extending through said slave bar and being connected to the attachment formation to which one of said end support cords is connected.

The system preferably includes at least some of the features of the earlier aspects of this invention. Thus, preferably said system further comprises
first and second mounting components to mount said head assembly in said glazed aperture, each component including a mounting bracket portion having at least one laterally extending planar finger configured to slide in use between the bead and the glazing pane; and
first and second connecting components configured operatively to attach the blind head assembly to the respective mounting components.

Preferably, said mounting components further comprise a base portion having a base surface configured to rest in use against the glazing pane and a post portion configured to extend in use approximately orthogonally with respect to the plane of the glazing pane, wherein said base and post portions are retained by said mounting bracket portion and said connecting components operatively attach the blind head assembly to the respective post portions of the mounting components.

According to a second embodiment of the invention there is provided a blind assembly mounted at a glazed aperture, the glazed aperture comprising a frame, a glazing pane retained in the frame and a flexible or resilient bead disposed between the glazing pane and the frame which bead bears against the glazing pane; the blind assembly comprising:
a blind head assembly from which a shade portion of the blind depends and including mounting means to mount the head assembly at the glazed aperture;
first and second mounting brackets, each comprising a first portion having at least a first laterally extending planar finger configured to slide in use between the bead and the glazing pane, and a second portion configured for mounting an additional component,
said second portion defining an attachment formation which extends substantially orthogonally with respect to the plane of the glazing pane; and
a support cord adapted for connection to and extending from one attachment formation through one end of said slave bar into the head assembly, through a tension mechanism, and down through the other end of said slave bar to said other attachment formation.

Preferably said mounting bracket second portions each include a second co-planar finger arranged to extend orthogonally with respect to the first finger and configured to slide in use between the bead and the glazing pane at adjacent sides of the frame.

Preferably, the blind assembly further comprises a support clip mounted on the attachment formation, said cord being connected to said support clip. Preferably, said support clip is a sliding fit on said attachment formation in a direction orthogonal to said pane and includes means to secure the support clip on said attachment formation. Preferably, said securing means comprises a tab on the attachment formation and a detent in the support clip, said tab snapping into said detent when the support clip is fully engaged with the attachment formation. Preferably, said full engagement includes seating of a flange of the support clip against the pane and masking said mounting bracket.

Preferably, said cord is connected to said support clip at a location spaced at a distance from said pane so that tension in the cord causes a moment on said bracket resisted by said bead. Preferably, first and second longitudinally extensive side members are configured to be mounted at the sides of the glazed window to extend from proximate the head assembly to proximate the mounting brackets;

Preferably, lower end portions of the side members engage the respective mounting brackets, such as by one of the mounting bracket or the side member including a slot into which the other of the mounting bracket or the side member is received. Thus, preferably the lower parts of the side members and the mounting brackets respectively include operatively co-operating engagement formations.

Preferably, the assembly further comprises:
first and second mounting components each including a mounting bracket portion having at least one laterally extending planar finger disposed between the bead and the glazing pane;
first and second connecting components by means of which the blind head assembly is attached to the respective mounting components.

Preferably, said first and second mounting components each further comprise a base portion having a base surface resting against the glazing pane, and a post portion extending approximately orthogonally with respect to the plane of the glazing pane and; wherein said base and post portions are retained by said mounting bracket portion and said connecting components operatively attach the blind head assembly to the respective post portions of the mounting components.

Preferably the mounting bracket portions are arranged at respective upper corners of the frame of the glazed aperture.

In preferred constructions of this aspect of the invention the mounting bracket portions each include first and second co-planar fingers extending orthogonally and arranged between the bead and the glazing pane at adjacent sides of the frame.

In one embodiment of this second aspect of the invention, the respective mounting components are unitary.

In another embodiment of this second aspect of the invention, preferably the first and second mounting components are non-unitary and respectively comprise:
first and second mounting formations each including a said base portion having a base surface resting against the glazing pane, and a said post portion extending substantially orthogonally with respect to the plane of the glazing pane; and
first and second head mounting brackets, respectively constituting the mounting bracket portions, and each comprising a first portion including attachment means by which the head mounting bracket and post portion of the mounting formation are attached and a second portion having said at least one laterally extending planar finger disposed between the bead and the glazing pane.

Preferably the attachment means comprise an aperture defined in the first portion of the mounting bracket through which aperture a respective post portion passes.

In preferred embodiments of this aspect of the invention, the respective post portions, apertures of the first portions and the base portions of the mounting formations are so sized and/or configured that the base portion cannot pass through the aperture.

Preferably, for attachment of the blind head assembly to the respective post formations, the respective connecting components are operatively slidable along the post portions. In this way, the position of the blind head assembly with respect to the frame is adjustable.

In preferred constructions the connecting components each comprise a socket within which the post portion is slidably engaged. Alternatively, the respective post portions of the mounting formations may define sockets into which a protruding formation of the respective connecting component is slidably received.

Preferably the blind assembly further comprises fixing means which co-operate with the respective connecting component and post portion to prevent or inhibit removal of the connecting component from the post portion. Fixing means may include a latching arrangement which resists removal of the connecting component, or permanent or semi-permanent fixing means such as a fixing screw, bolt or pin.

Preferably the blind assembly further comprises at least first and second spacing elements of predetermined depth arranged respectively between the mounting bracket portion or mounting bracket and the connecting component.

Preferably the retaining means comprise first and second clips each including an engagement portion which engages the side member and a finger portion which slides between the bead and glazing pane.

Preferably, lower end portions of the side members engage the respective first and second mounting brackets, such as by one of the mounting bracket or the side member including a slot into which the other of the mounting bracket or the side member is received. Thus, preferably the lower parts of the side members and the first and second mounting brackets respectively include operatively co-operating engagement formations.

Thus, with the arrangement of the present invention, or at least the fourth aspect of it, once the dimensions of the glazed aperture are known, it is possible to set up the blind in the factory on the jig, whereby the installer simply clips the blind in place and the requisite tension on the supporting cords are preset.

Moreover, with this arrangement, the tension in the cords is transmitted directly to the attachment mechanism of the blind at each corner and, while these directionally appear to tend towards pulling the attachment mechanisms towards one another and therefore out of engagement with the top and bottom beads of the glazing, in fact this direction is at a distance from the plane of the pane so that on each post and attachment formation, the tension in the cords applies a moment at the base against the pane, the reaction to which is the planar fingers pressing outwardly against the bead, whereby the grip of the bead resisting pullout is increased. The effect therefore of the tension arrangement is not just to provide a rigid guide in the form of taut cords for the pleats or slats, but to pre-tension all the attachment mechanism of the blind to the glazed pane, all without the necessity to use screw fixings.

In another aspect, the present invention provides a method of mounting a blind at a glazed aperture, the blind comprising a head assembly, a blind panel attached to the head assembly and support cords to support the sides of the blind panel, and the glazed aperture comprising a frame, a glazing pane retained in the frame and a flexible or resilient bead disposed between the glazing pane and the frame which bead bears against the glazing pane; the method comprising:
mounting the head assembly to the glazed aperture;
providing a bottom anchor for said support cords, said anchor comprising first and second mounting brackets, each comprising a first portion having at least a first laterally extending planar finger configured to slide in use between the bead and the glazing pane, and a second portion defining an attachment formation which extends substantially orthogonally with respect to the plane of the glazing pane, and connection means on said attachment formation for connection of said support cord for the blind at a distance from the glazing pane;
sliding the fingers of said first and second mounting brackets between the glazing pane and the bead at bottom corners of the glazing pane;
attaching the cord to the attachment formations so that it is under tension between the anchor and the head assembly

In another aspect, the present invention provides a bottom anchor for a blind to be mounted at a glazed aperture, the blind including a head assembly from which extends one or more blind panels, and the glazed aperture comprising a frame, a glazing pane retained in the frame and a flexible or resilient bead disposed between the glazing pane and the frame which bead bears against the glazing pane,
said anchor comprising first and second mounting brackets, each comprising a first portion having at least a first laterally extending planar finger configured to slide in use between the bead and the glazing pane, and a second portion defining an attachment formation which extends substantially orthogonally with respect to the plane of the glazing pane; and
connection means on said attachment formation for connection of a support cord for the blind at a distance from the glazing pane.

Preferably, said second portion is configured for mounting an additional component comprising said attachment formation. Said attachment formation may be a snap fit on said second portion.

For a better understanding of the invention and to show how the same may be carried into effect, reference is made, by way of example only, to the following drawings, in which:

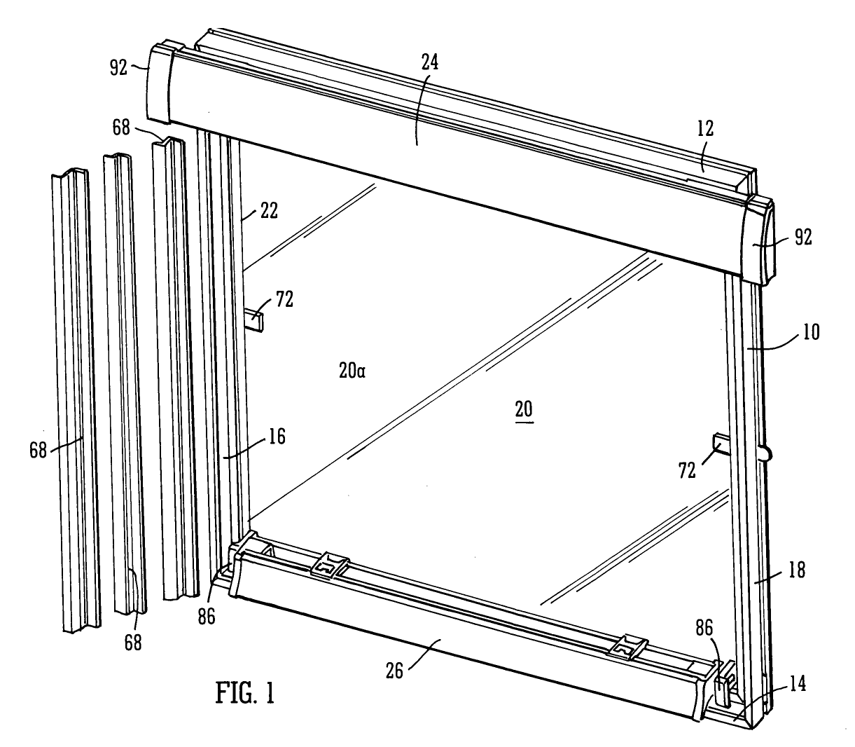

FIG. 1 is a perspective view of a blind head rail and bottom mounted at a window;

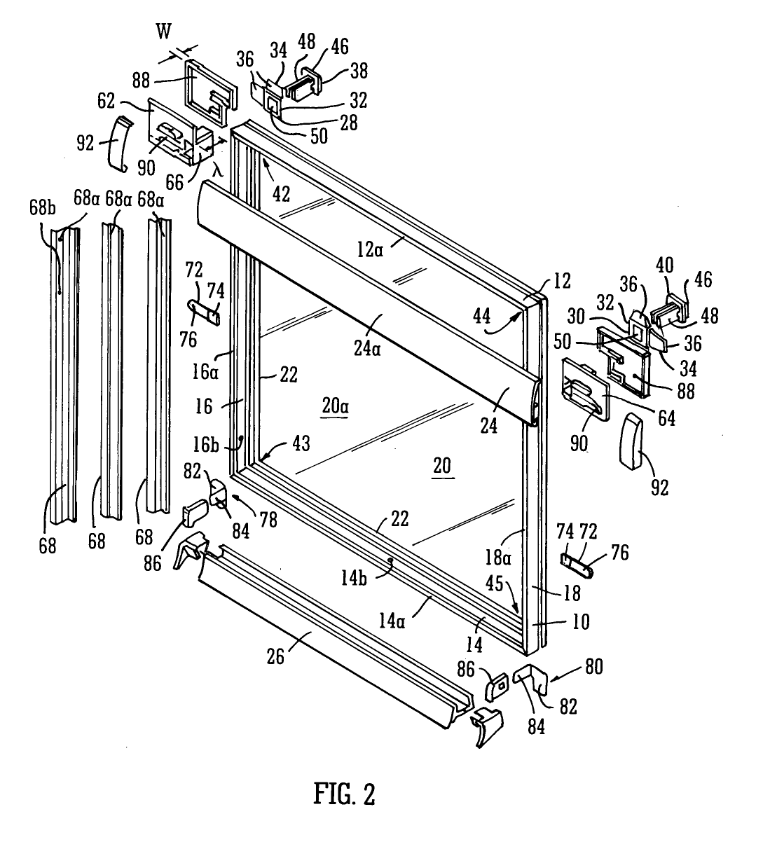

FIG. 2 is an exploded view of the system of FIG. 1;

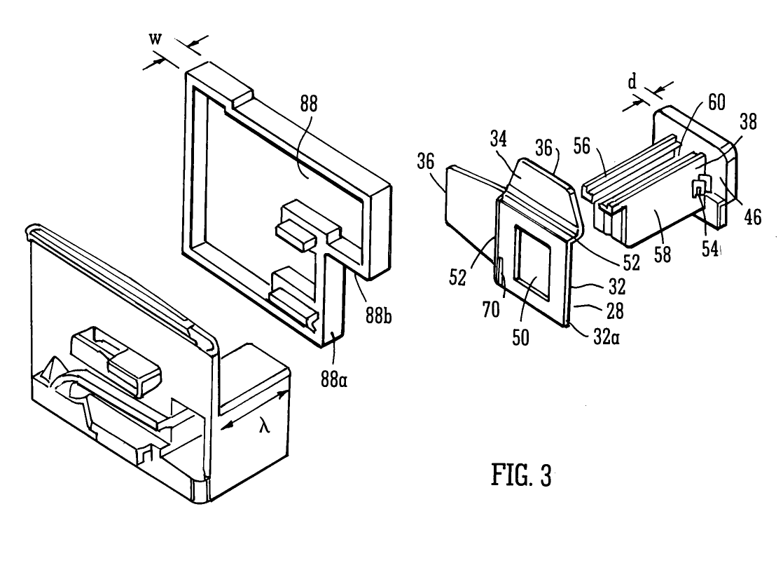

FIG. 3 shows a portion of the head rail mounting of FIGS. 1 and 2 on an enlarged scale;

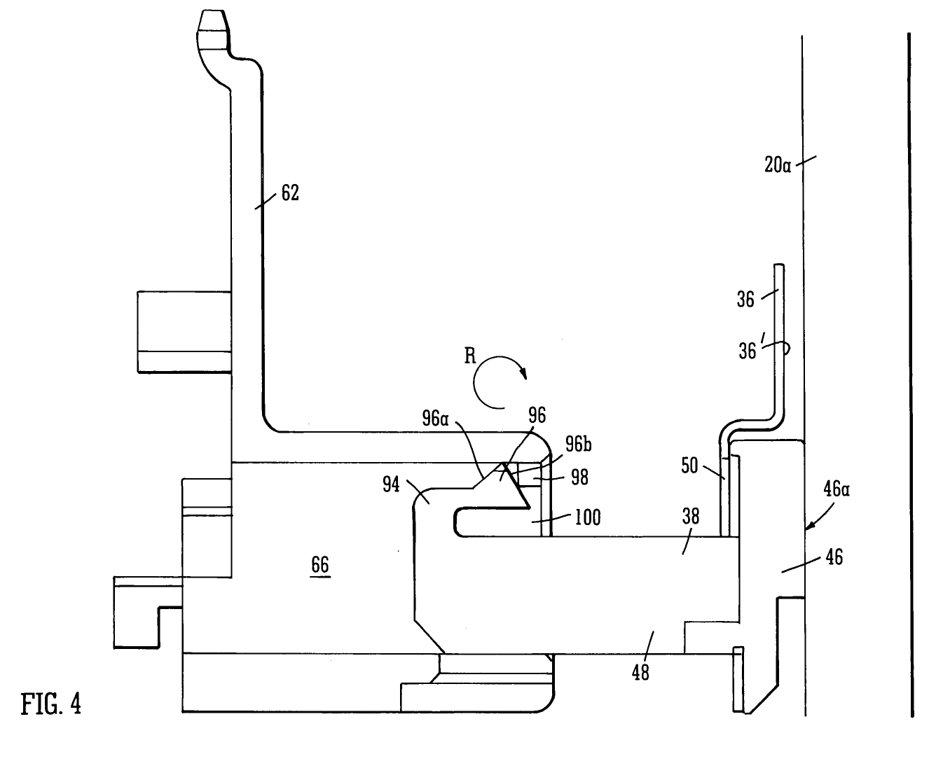

FIG. 4 is a cross section through a combined mounting bracket, mounting formation and connecting component according to a variation of the invention;

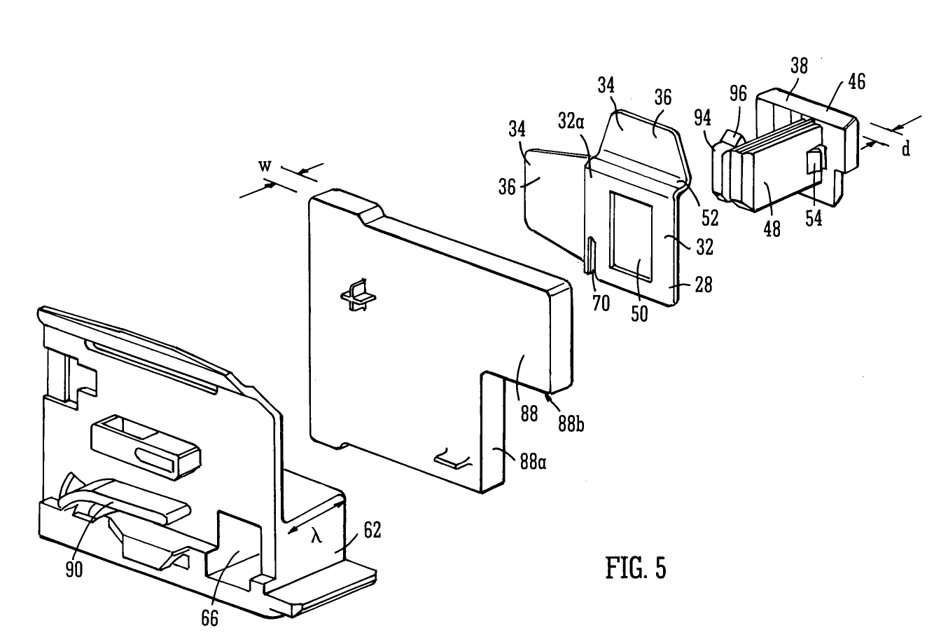

FIG. 5 is an exploded perspective view of the mounting bracket, mounting formation and connecting component of FIG. 4, together with a support clip;

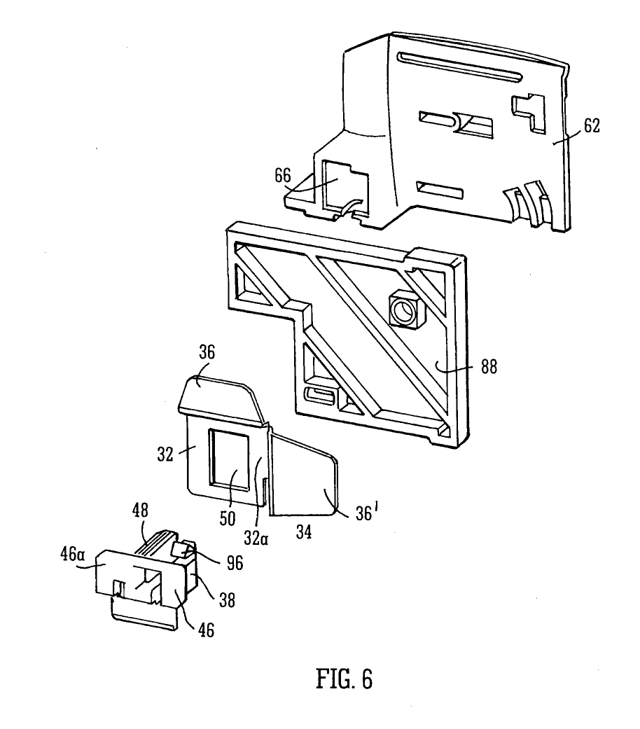

FIG. 6 is an exploded perspective view of the mounting bracket, mounting formation support clip and connecting component of FIG. 5, viewed from the other side;

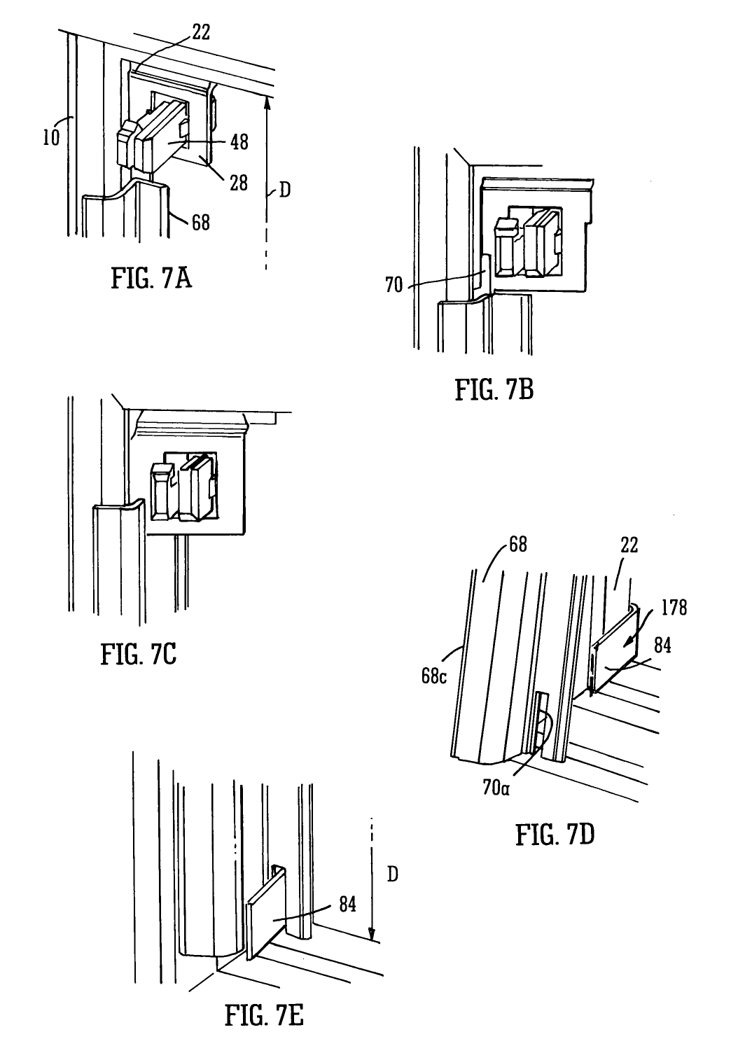

FIGS. 7 a to e show the mounting sequence of top and bottom brackets, and side members of the system shown in FIGS. 1 through 6;

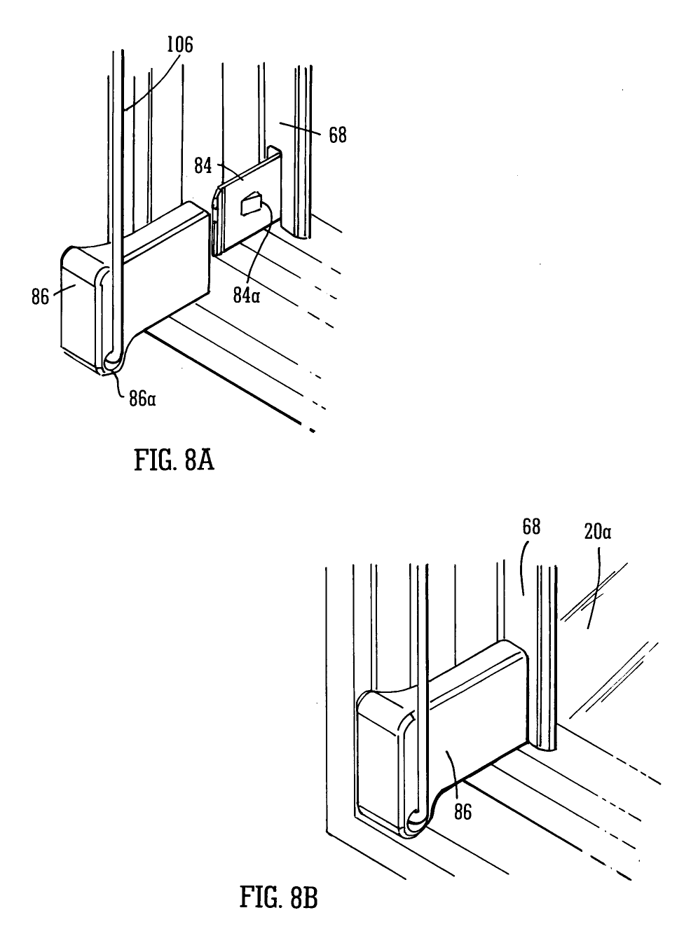

FIGS. 8 a and b show use of the bottom brackets in accordance with the present invention, continuing the sequence in FIG. 7;

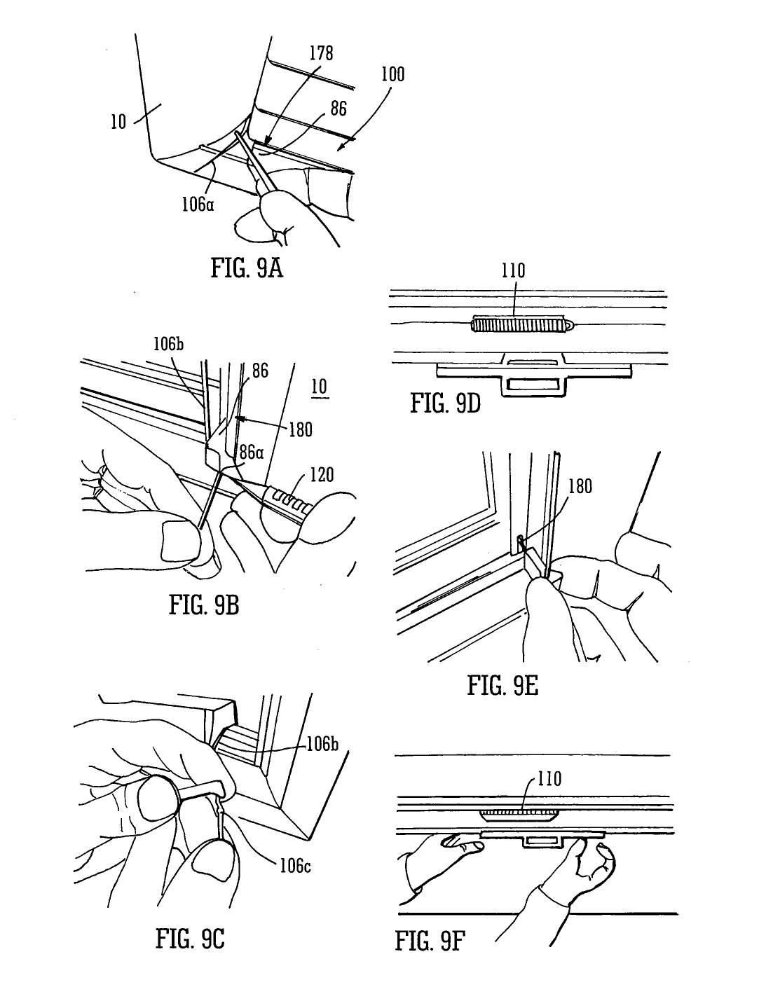

FIGS. 9 a to f show the sequence of operations in tensioning support cords, in accordance with the present invention; and

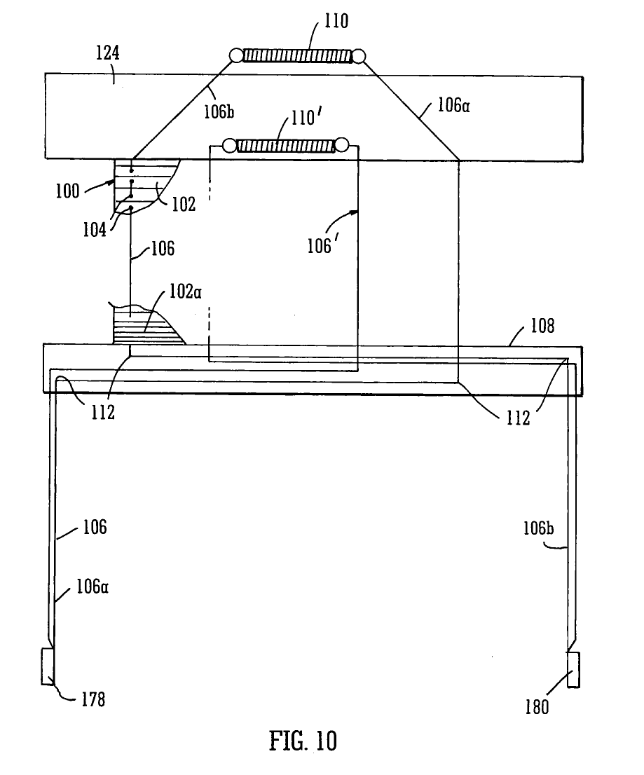

FIG. 10 is a schematic diagram of a system in accordance with the present invention

Referring now to the drawings, the system is described specifically in relation to the mounting of a Venetian blind, but it is not confined only to Venetian blinds and includes the mounting of other types of blind.

The blind is mounted at a window frame 10. The frame 10 conventionally comprises an upper horizontal frame member 12, a lower horizontal frame member 14 and vertical side frame members 16, 18 which are connected together to form the frame 10, thereby defining upper corners 42, 44 and lower corners 43, 45. The frame defines an aperture 20 which is closed by a pane of glazing 20a, which may be glass or other transparent or translucent material such as a sheet of light transmitting plastic. A typical frame member 12, 14, 16, 18, as illustrated, may comprise a front face 12a, 14a, 16a, 18a which is normally arranged substantially parallel to the plane of the glazing pane 20a and a return face (14b, 16b) which is normally arranged approximately perpendicular to the glazing pane 20 and to the front face (12a, 14a, 16a, 18a). Other configurations, especially with respect to the return face 14b, 16b, are possible, in accordance with aesthetic considerations of the frame designer. For example, the frame members 12, 14, 16, 18 may include a more complex series of faces which may be plane or curved. The glazing pane 20a is retained in the frame 10 by use of a bead 22 of flexible or resilient material, such as of a rubber compound or rubber-like polymeric material. The bead 22 is arranged between the frame 10 and the glazing 20a. The frame members 12, 14, 16, 18 are typically made from a plastic (normally uPVC) but other materials are also possible such as metal or wood, provided only that the glazing pane 20a is retained by a bead and that there is space within the frame members to accommodate mounting means as discussed below.

Venetian or pleated blinds conventionally include a head rail or master rail 24. Other types of blind will also conventionally include a head rail, master rail or other substantially rigid element member or assembly by which the shading part of the blind is supported, for example, from which the shading part is suspended. The blind itself is not shown in the drawings for reasons of clarity. The head rail or master rail 24 typically has a decorative front face 24a which is visible to a user. Operating components of the blind such as cords, cord guides and a tilt mechanism are accommodated within the blind head rail or master rail 24. Such components are ancillary to the present invention. Venetian and pleated blinds commonly also comprise a second, bottom or slave rail 26 which, depending on the particular design, may be fixedly located in the window aperture opposite the head rail or master rail 24, for example, against the lower horizontal frame member 14, or may be adapted to be moved with the shading part of the blind (e.g. raised and lowered).

The system allows a blind to be attached to a window frame without the use of fixing means which require a hole in, or otherwise damage, the frame. For example, screw fixings which penetrate the frame are avoided.

Referring now in particular to FIG. 2 the system of the system includes first and second mounting components which in the embodiment illustrated are non-unitary and consist respectively of mounting bracket portions 28, 30 and mounting formations 38, 40. The mounting bracket portions 28, 30 are preferably, but not essentially, made from metal. For example, the mounting bracket portions can be made from a suitably strong plastic which is also suitable for moulding to form the bracket. In use, the mounting bracket portions 28, 30 are located at the upper left and right (as illustrated) corners 42, 44 of the frame 10, that is, respectively where the frame members 12 and 16 and the frame members 12 and 18 join. The mounting bracket portions 28, 30 each comprise a first portion 32 which defines attachment means (see below) and a second portion 34 which includes at least one laterally projecting finger and preferably two laterally projecting fingers 36. Where the mounting bracket portion 28, 30 includes only a single finger, the finger may, for example, be a generally “L” shaped web, with each arm of the “L” being connected along its length to the first portion 32. Where the mounting bracket portion 28, 30 includes two fingers 36, the fingers 36 are in the form of planar webs which extend from the first portion 32. The fingers 36 of a given mounting bracket 28, are substantially co-planar and rest in their position of use against (or at least closely proximate) the surface of the glazing pane 20a. The finger or fingers of the mounting bracket portion is/are arranged to slide between the glazing pane 20a and the bead 22, to retain the bracket in position. In the illustrated example, the fingers 36 of bracket portion 28 are directed at right angles (i.e. perpendicularly or orthogonally) so that when the bracket portion 28 is arranged in its corner 42 one of the fingers slides between the bead 22 and glazing pane 20a into the upper frame member 12 and the other of the fingers 36 slides between the bead 22 and the glazing pane 20a into side member 16. Similarly, the fingers of bracket 30 are directed at right angles so that when the bracket 30 is arranged in its corner 44 one of the fingers slides between the bead 22 and the glazing pane 20a into the upper frame member 12 and the other of the fingers slides between the bead 22 and the glazing pane 20a into the side member 18. The bracket portions 28, 30 are mirror images of one another.

The system of the invention further includes said first and second mounting formations 38, 40 which are arranged at respective corners 42, 44 of the frame 10 and which co-operate with respective mounting bracket portions 28, 30 for supporting the blind in use. Each mounting formation 38, 40 comprises a base portion 46 and a post portion 48. The base portion 46 has a substantially flat rear surface (or coplanar surface portions) 46a which rest in use in contact with the surface of the glazing pane 20a. The post portion 48 depends from the first portion and extends approximately orthogonally (i.e. perpendicularly) with respect to the plane of the glazing pane 20a.

As noted above, the mounting bracket portions 28, 30 each have a first portion 32 defining attachment means. The attachment means co-operate with the respective mounting formation so that the mounting formation 38, 40 is constrained from movement with respect to the mounting bracket portion 28, 30 in directions substantially parallel to the plane of the glazing pane 20a and also in directions substantially perpendicular to the plane of the glazing pane 20a. Preferably, the mounting bracket portion 28, 30 and the mounting formation 38, 40 are attached to or retained on one another. In the preferred embodiment as illustrated, the first portion 32 of the mounting bracket portion 28, 30 comprises a web 32a defining an aperture 50. The web 32a is preferably substantially planar, the plane of web 32a, when the bracket portion 28, 30 is in its position of use, being approximately parallel to that of finger(s) 36. The post portion 48 is, in use, seated in the aperture 50 so that the base portion 46 lies between the web 32a and the glazing pane 20a. Each mounting bracket 28, 30 has depending walls 52 by which the first portion 32 is connected to the second portion 34. Preferably the material from which the bracket portion 28, 30 is constructed can accommodate a small degree of deformation between the fingers 36 and the web 32a. Thus the web 32a is spaced apart from the fingers 36 by a distance nominally equal to, and preferably slightly less than, the depth “d” of the base portion 46 of the mounting formation 38, 40 (see FIG. 3). In other words, the web 32a and the walls 52 are sized to accommodate the base portion 46 so that, when the post portion 48 is arranged in the aperture 50, the base portion 46 lies flat against the glazing pane 20a. In the preferred construction the surface 46a of the base portion 46 is proud of the under-surface 36′ of the fingers 36 (that is, depth “d” is greater than the depth of walls 52) which ensures that the glazing pane 20a is contacted by the base portion 46 (which is preferably made of a plastics or other polymeric material) in preference to the (metal) bracket portion 28, 30. This construction is advantageous in that forces due to the inherent weight of the blind and also operation forces of the blind (which principally occur when raising or lowering the blind) are not primarily transferred via to the metal brackets and thence to the glazing. Rather, such forces are transferred through the base portion 46. As noted above, in the prior art, transfer of such forces through metal brackets potentially transfers stresses to the glazing very locally through the edges of the metal brackets.

In an alternative configuration, the mounting bracket portion 28, 30 and the mounting formation 38, 40 may be formed as a unitary component. In this case, the unitary mounting component includes a base portion having a base surface which contacts the glazing pane 20a in use, a mounting bracket portion including at least one laterally projecting finger (similar to fingers 36) and a post portion similar to post potion 48.

The post portion 48 may advantageously include one or more outwardly projecting latching formations 54 which act to engage edge parts of the web 32a which define the aperture 50, thereby to retain the mounting bracket 30, 32 on the post portion 48. In some preferred forms, the post portion 48 comprises first and second parallel arms 56, 58 separated by a narrow channel 60. In alternative arrangements, the post portion 48 is unitary and may include a groove extending along the length of the post portion 48.

The apparatus or system shown further comprises first and second connecting components 62, 64 which serve to attach the head assembly (head rail 24 in the illustrated embodiments) to the post portions 48 and thus to the frame 10 via the mounting bracket portions 28, 30. The connecting components 62, 64 are located at or near the left and right end portions of the head rail 24, on the rear side of the head rail 24 where they are not normally visible to a user. The connecting components 62, 64 may be formed integrally with the head rail 24, or, more preferably, are separate components which are securable to the head rail 24. For example, the head rail 24 and the connecting components 62, 64 may have co-operating engagement formations which allow the connecting components 62, 64 to “snap-fit” to the head rail 24, or such formations may allow the connecting components to slide into engagement with the head rail 24 from the side edges thereof.

Each connecting component 62, 64 includes means for attaching the connecting component 62, 64 to a respective post formation 48. In one example as illustrated, such means comprise a socket 66, the internal shape and dimensions of which are sized to conform with the external shape and dimensions of the post portion 48. Thus the socket 66 operatively slides into engagement with the post portion 48. The socket may include a slot or a channel which, when the connecting component 62, 64 is in its position of use, aligns with the channel 60 of the post portion 48. The channel of the connecting component 62, 64 and the channel 60 of the post portion 48 are used for securing the connecting component 62, 64 on the respective post portion 48 in its position of use. Thus, when the post portion 48 is received in the socket 66, the two may be secured together by inserting a screw or like fixing means into the respective channels. In this respect the channels and screw are sized so that the width of the channels is somewhat less than the width of the thread of the screw, so that the thread engages the sides of the channels and thereby secures the post portion 48 and the socket 66 together. Preferably in this variation the channel of the socket 66 includes an outer wider portion sized to accommodate the head of the screw and an inner, narrower, portion sized to conform with the thread portion of the screw. It will be understood that other fastening means may be employed to secure the post portion 48 and the socket 66 together. For example, the post portion may include a captive nut which is free to slide along the length of at least part of the post portion 48 and which receives a corresponding bolt via a channel in the socket 66.

It can also be readily appreciated that the present invention is not confined to a post and socket arrangement where a post portion 48 of a mounting formation 38, 40 is inserted into a socket 66 of a connecting component 62, 64. Thus, for example, the post portion 48 may be formed with one or more walls which define an internal hollow void which acts as a socket, the internal shape and dimensions of which are sized to conform with the external shape and dimensions of a projecting member (plug) formed on the connecting component 62, 64, so that the plug is slidably received in the socket.

A significant advantage of the post portion 48 and socket 66 arrangement is that the connecting components 62, 64, and hence the head rail 24 are almost infinitely adjustable with respect to the length of the post. Thus, the head rail 24 can be set at any required depth on the post portions 48 to accommodate different depths of the window frame 10, that is, the distance from the front face 12a, 14a, 16a, 18a to the surface of the glazing pane 20a. This ensures that no unintended gap is left between the head rail 24 and the frame 10.

In a preferred arrangement, as shown in particular in FIG. 4, the mounting formations 38, 40 are configured so that the post portion 48 is inclined slightly upwardly, typically by not more than about 10°, preferably not more than about 5° and more preferably not more than about 2° to 3° (with respect to a line perpendicular to the plane of the glazing pane 20a). This feature is advantageous in preventing the blind, when mounted, from tilting forwards away from the window. In the embodiment of FIG. 4, the base portion is provided with a formation or lip 46b which bears against the web 32 and ensures that the base portion 46 and the web 32 are not in exactly parallel alignment.

The embodiment of FIGS. 4, 5 and 6 further shows a safety latching arrangement which acts to prevent unintended separation of the connecting component 62, 64 from the mounting formation 38, 40. Post portion 48 comprises an arm 94 which is preferably resiliently deformable and which terminates in a raised formation 96 with inclined surfaces 96a, 96b. Socket 66 includes a lip 98 which is conveniently provided near the mouth 100 of the socket 66. The arm 94, formation 96 and lip 98 are so configured that on insertion of the post portion 48 into socket 66, or removal of the post portion 48 from the socket 66, lip 98 interferes with the passage of arm 94. Thus the arm 94 may be deflected by the lip 98. Alternatively, or additionally, the arm 94, the lip 98, and the internal dimensions of the socket may be so configured that it is necessary for removal of the connecting component 62, 64 to rotate the connecting component relative to the post portion 48 as suggested by arrow R such that the inclined surfaces 96a, 96b and the lip 98 do not interfere with one another. It follows that socket 66 cannot inadvertently be removed from post portion 48 without overcoming the resistance to deflection of arm 94.

In order, inter alia, to provide additional security to the attachment of the blind head rail 24 to the window frame 10, the system is desirably further provided with side members 68 which are arranged in use to lie in confronting relation with frame side members 16, 18. The side members 68 extend from an upper part of the aperture 20 close to the respective upper corners 42, 44 to a lower part of the aperture close to respective lower corners 43, 45. Preferably upper parts 68a of the side members 68 are in contact with a respective mounting bracket 28, 30 or mounting formation 38, 40. Most preferably, the side members 68 and respective mounting bracket portions 28, 30 include co-operating formations by which the side members 68 and mounting bracket 28, 30 are joined, attached or engaged. For example, the mounting bracket portion 28, 30 may conveniently include a slot 70 which receives an upper end portion of face 68b of the side member 68. The side member 68 may be selected from a number of different shapes and configurations which are adapted for different sizes and profiles (e.g. depths) of the frame 10. Three different side members 68 are shown in FIGS. 1 and 2 by way illustration of different possible shapes and configurations.

Means are also provided for attaching the side members to the frame 10. In the preferred embodiment as illustrated, attachment clips 72 are provided which include a head portion 74 configured to engage the side member 68 and a flat finger portion 76 configured to slide between the glazing pane 20a and the bead 22, thereby to retain the side member in its position of use.

The above arrangements are described in our copending application number GB0615518.8 and to which the present invention indirectly relates. That application goes on to describe third and fourth mounting brackets 78, 80. However, these also constitute examples of the first and second mounting brackets of the present invention. However, completing the description of the system described above, they are referred to as third and fourth mounting brackets.

Third and fourth mounting brackets 78, 80 are also preferably provided configured to sit in respective lower corners 43, 45 of the frame 10. In a similar manner to the first and second mounting bracket portions 28, 30, each of the third and fourth brackets 78, 80 includes a planar finger portion 82 which is arranged to slide in use between the glazing 20a and the bead 22 in the region of the corners 43, 45. The mounting brackets 78, 80 also include an upstanding attachment or mounting formation 84 which extends away from the plane of the glazing 20a. In the illustrated embodiment, the attachment formation 84 comprises a web or finger extending orthogonally with respect to the glazing 20a. In use, each attachment formation 84 carries a cap or support clip 86 which is typically formed from a plastics material. In preferred arrangements, the distance between the two spacing formations 86 substantially corresponds to the length of the foot rail 26. Thus, where the foot rail 26 is moveable, the spacing formations 86 assist in retaining the foot rail 26 in position when it is in its lowermost position. Side members 68 may include at their lower ends a slot or cut-out in which the attachment formation 84 is accommodated. Alternatively, the third and fourth mounting brackets 78, 80 may each include a slot or cut out in which a lower part of a side member 68 is accommodated.

As noted above, an important advantage of the system illustrated is the facility to adjust the mounting of the head rail by longitudinal movement of the socket 66 on the post portion 48, thereby to accommodate different constructions of the frame 10. In order to facilitate the secure and accurate positioning of the head rail 24, one or more spacing elements 88 are preferably provided which are configured to sit between the head rail 24 (more specifically, the respective connecting component 62, 64) and the frame 10. This allows for the case where the combined length λ of the socket 66 and the depth d of the base portion 46 is greater than the depth of the frame 10 (that is, the distance from the front face 12a, 14a, 16a, 18a to the surface of the glazing), or, for the case where the length of the post portion 48 is greater than the depth of the frame 10. To accommodate different depths of frame, a selection of spacing elements 88 can be provided each having a different depth w. By choosing a spacing element of appropriate depth w it is thus possible to ensure that no gap, or substantially no gap, is present between the internal or rear face of the head rail 24 (or, more specifically, the rear face of the connecting component 62, 64) and the front face of the frame 10. Likewise, the head rail 24 may be constructed to have a lower face which, by use of spacing elements 88 of appropriate depth, extends to meet the glazing pane 20a without any significant gap. Each spacing element 88 includes edge wall portions 88a, 88b which define a recess or cut-out which is sized and shaped to conform to the external shape of the socket 66.

Where, in particular in the case of Venetian blinds, the head rail 24 accommodates a lift and/or tilt mechanism for the blind which employs operating cords, the connecting components 62, 64 may desirably include cord guiding formations 90 to direct the cords along a desired and predetermined path into the head rail. End caps 92 may be provided to close the ends of the head rail 24 and provide a more aesthetically pleasing finish.

In a preferred method of mounting a blind in a glazed aperture such as a window, initially the post portions 48 of the first and second mounting formations 38, 40 are inserted into the respective apertures 50 of the mounting bracket portions 28, 30. Where latching formations 54 are present (as is preferred), the post portions 48 are inserted to an extent sufficient to cause the latching formations 54 to engage the edges of the web 32a which define aperture 50. The first and second mounting bracket portions are located at the respective upper corners 42, 44 of the frame 10, so that fingers 36 extend between the bead 22 and the glazing 20a into the respective frame members 12, 16 and 12, 18. Side members 68 are then fixed in place using clips 72 and with upper portions thereof engaged in slot 70 of respective mounting bracket portions 28, 30. At the same time, third and fourth mounting brackets 78, 80 are engaged with the side members (via, for example, the slot or cut-outs provided) and the finger portions thereof are inserted into the respective corners 43, 45 of the frame between the glazing pane 20a and the bead 22. Support clips 86 are mounted on the mounting formations 84 of the third and fourth mounting brackets 78, 80. If required, suitably sized spacing elements 88 are mounted around the post portions 48 of the mounting formations 38, 40. Connecting components 62, 64 are mounted to head rail 24 and sockets 66 are mounted on post portions 48 and if necessary secured in place with fixing means provided. The head rail 24 carries all the components of the blind, including the shade portion, tilt mechanism and so on. Thus, mounting of the head rail on the post portions 48 (via the connecting components 62, 62) completes the installation of the blind. The head assembly (head rail 24 in the illustrated embodiments), being substantially rigid, serves to ensure that the mounting bracket portions 28, 30 cannot move laterally (parallel to upper frame member 12). Side members 68 prevent movement of the mounting bracket portions 28, 30 parallel to frame side members 16, 18. Thus, the combination of these integers in effect provides a structure which retains the mounting bracket portions 28, 30 in their intended position and assists in the transfer of operating forces from the head rail, without allowing such forces to be transferred to the glazing pane 20a through potentially relatively sharp edges of the mounting brackets 28, 30. Instead, forces are transferred primarily through the base portions 46 of the mounting formations 38, 40.

As mentioned above, the above description is primarily of a blind in accordance with the invention of GB0615518.8. The reason for such description is that present invention can be employed in such a system, although this should not be understood to be a limitation of the present invention.

In the present invention a blind 100 (see FIG. 10) may comprise a pleated panel 102 provided with holes 104 through which a support cord 106 is threaded whereby the blind panel 102 is supported. At its bottom end, the panel 102 is connected to a slave bar 108, and if the slave bar is at an intermediate position in the window frame, the bottom pleats 102 will be concertinaed into a stack 102a of pleats. The cord 106 serves to keep the pleats tidy and in the same plane. A similar arrangement can be employed with other types of blind, particularly when a blind is not to be vertical and gravity cannot be employed to retain the position of the blind. This occurs particularly in roof windows. Of course, to function in this way, the cord 106 must be constrained and this is achieved by connecting the cord in head rail 124 of the blind 100 and securing its lower end at the case of the blind 100. Traditionally, this has been achieved by the use of screw fixings, but the present invention avoids that requirement by employing first and second mounting brackets 178, 180, which of course may be the same as the third and fourth mounting brackets 78,80 described above with reference to FIG. 2.

In any event, the cord 106 (on both sides of the blind of course, as shown at 106a,b) is retained in position and tensioned by tensioning means 110. Such means may take any convenient form, but here is illustrated as a spring to the ends of which one each of cord 106a,b is connected. The spring 110 is normally located in the head rail 124. It will be noted that the cord 106 crosses from one side to the other in slave bar 108. The only purpose of this is to introduce a serpentine path so that the bar 108 does not simply fall under its own weight to a lowermost position but will adopt which ever position it is placed in by the user, friction of the cord at the various corners 112 it negotiates in the slave bar 108. Of course, there is no absolute need for cross over, provided there is some friction means. Importantly, however, to give effect to the friction means, and to ensure that lifting of the slave bar 108 does not fail to produce a change in position of the slave bar when released by the user, it is imperative that the cord 106 is not slack. This is ensured by the spring means 110, and of course by appropriate choice of length of the cord 106.

Also shown in FIG. 10 is the possibility of a further pair of intermediate support cords 106′ disposed between what are, in the event of such intermediate support cords, end support cords 106a,b. A separate tension spring 110′ is provided and like the cord 106, the intermediate cord 106′ describes a figure-8 arrangement in the slave bar 108 but, instead of exiting the slave bar aligned with the cords above, they exit beside the cords 106a,b so that they can be tied off on the same attachment formations 178, 180. Further cords could be provided, and not necessarily in pairs as shown. Also, it is not essential for the spring 110, 110′ to be in the head rail 124, but could equally well be in the slave bar 108, or else where (eg outside the head rail 124 as shown for the spring 110).

Turning to FIGS. 7 a to e, the blind mounting system described above with reference to FIGS. 1 to 5 is illustrated in different stages of assembly. In FIG. 7a, bracket portion 28 has been inserted behind bead 22, captivating post formation 48. Side member 68 is being offered up to the bracket portion 28 to engage in slot 70 (see FIG. 7b). Once engaged (FIG. 7c), lower end 68c of side member 68 engages over mounting formation 84 of first mounting bracket 178. The length of the side member 68 is determined by the depth D of the window frame, as this determines the separation of the brackets 28,84. Lower end 68c of the side member 68 has a slot 70a to engage over mounting formation 84.

Turning to FIGS. 8a,b, support clip (or cap) 86 is then clipped over mounting formation 84, being retained in place, for example, by a punched tab 84a and corresponding catch (not shown) inside the cap 86. Cap 86 is provided with an eye 86a through cord 106 is threaded and knotted and the action of clipping the second cap 86 over the second mounting formation 84 has the effect of tensioning the cord 106. Clipping cap 86 onto formation 84 also has the function of locking the side member 68 in place. The tension in the cord 106 tends to lift the mounting formation 84 and would tend to disengage bracket 178 from the bead 22. Firstly, the tension is at a distance from the pane 20a, and consequently results rather in a twist of the finger portion 82 (not visible in FIG. 7 or 8), rather than any extraction in a direction parallel the plane of the pane 20a, and, in any event, the side member 68 directly opposes any such force. Instead, the tension in the cord simply tightens the overall structure of the components of the blind 100.

The length of the cord 106 determines the appropriate tension of it. This tension is something that can be set by the installer. However, getting the tension right is a skill that is better not left in the hands of the installer, who possibly may not understand the benefit of the appropriate tension. If the size of the window frame in which the blind is to be fitted then a jig can be constructed whose dimensions are set the same as the frame.

Turning to FIGS. 9a to f, the process of adjusting the cord length of achieve the appropriate tension is illustrated. The blind 100 is fully assembled in the jig (in fact, in the photographs forming FIG. 9, a window frame 10 is employed). To the first mounting bracket 178, or rather its support clip 86, the cord 106a is fixed by threading through its eye 86a and knotting on the far side thereof. On the other side of the frame 10, the other end of the cord 106b is threaded through the eye 86a of the cap 86 on the second mounting bracket 180, and pulled until it reaches the appropriate tension. This is achieved by watching spring 110 expand by a reasonable percentage (ie so that it has plenty of extension in either direction without, on the one hand, becoming coil bound, or on the other hand, extending beyond its elastic limit). The cord is then marked behind the eye 86a with a pencil 120 or similar, before the cap 86 on the second mounting bracket is released from its mounting formation 84. (Indeed, in the factory, this formation may not have the tab 84a so that disconnection is simplified). A knot 106c is then tied in the cord 106b and so the tension is set. The blind can then be despatched to its destination so that, when the cap 86 is connected to the second mounting bracket 180 at the installation site (see FIG. 9e) the spring will have the appropriate tension (see FIG. 9f).

While the above description is exclusively in relation to a blind as described with reference to FIGS. 1 to 6, the present invention is not limited thereto. Indeed, even with the same blind, some people may not be content with the security of the mounting for the head rail and choose to employ screw fixings. This does not affect the benefit of the present invention, in cases where tensioned support cords are provided and screw fixings at more visible locations than the top of the window frames are desirably avoided.

Likewise, in conventional blinds, the anchors provided by the mounting brackets 178, 180 and caps 86 may have application in avoiding the necessity of screw fixing the bottom ends of the cords to the widow frame, or providing a fixed bottom rail for the cords. Instead, the anchors in accordance with the present invention may be employed.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1-57. (canceled)

58. A system for mounting a blind at a glazed aperture, the blind including a head assembly and a slave bar between which extends one or more blind panels, the glazed aperture comprising a frame, a glazing pane retained in the frame and a flexible or resilient bead disposed between the glazing pane and the frame which bead bears against the glazing pane; the system comprising:
mounting means for the head assembly, to mount the head assembly at or near the top of the glazed aperture;
first and second lower mounting brackets, each comprising a first portion having at least a first laterally extending planar finger configured to slide in use between the bead and the glazing pane, and a second portion defining an attachment formation which extends substantially orthogonally with respect to the plane of the glazing pane; and
a support cord adapted for connection to and extending from one attachment formation through one end of said slave bar into the head assembly and down through the other end of said slave bar to said other attachment formation.

59. A system as claimed in claim 58, in which a tension mechanism tensions the cord.

60. A system as claimed in claim 59, in which, said tension mechanism is in said head assembly.

61. A system as claimed in claim 58, in which said lower mounting bracket first portions each include a second co-planar finger arranged to extend orthogonally with respect to the first finger and configured to slide in use between the bead and the glazing pane at adjacent sides of the frame.

62. A system as claimed in claim 58, in which the blind assembly further comprises a support clip mounted on the attachment formation, said cord being connected to said support clip.

63. A system as claimed in claim 62, in which said support clip is a sliding fit on said attachment formation in a direction orthogonal to said pane and includes means to secure the support clip on said attachment formation.

64. A system as claimed in claim 63, in which said securing means comprises a tab on one of the attachment formation and the support clip and a corresponding detent in the other of the attachment formation and the support clip, said tab snapping into said detent when the support clip is fully engaged with the attachment formation.

65. A system as claimed in claim 64, in which said full engagement includes seating of a flange of the support clip against the pane and masking said first or second lower mounting bracket.

66. A system as claimed in claim 63, in which said cord is connected to said support clip at a location spaced at a distance from said pane so that tension in the cord causes a moment on said first or second lower mounting bracket resisted by said bead.

67. A system as claimed in claim 58, in which first and second longitudinally extensive side members are configured to be mounted at the sides of the glazed window to extend from proximate the head assembly to proximate the first and second lower mounting brackets.

68. A system as claimed in claim 67, in which lower end portions of the side members engage the respective first and second lower mounting brackets.

69. A system as claimed in claim 68, in which one of the first and second lower mounting brackets or the side member includes a slot into which the other of the first and second lower mounting bracket or the side member is received.

70. A system as claimed in claim 67, in which the tension in said cord when the system is installed in the glazed aperture is set remotely, prior to installation of the blind, wherein the length of said cord is determined by the length of said side members which themselves determine the separation of said attachment formation from said head assembly.

71. A system as claimed in claim 70, in which an adjustable jig is provided whose dimensions are adjustable to correspond with said glazed aperture, whereby the blind may be fitted in the jig and the tension in said cord set prior to installation of the blind in said glazed aperture.

72. A system as claimed in claim 59, in which the tension in said cord when the system is installed in the glazed aperture is set remotely, prior to installation of the blind, wherein the length of said cord is determined by the length of said side members which themselves determine the separation of said attachment formation from said head assembly and in which said cord is relatively inextensible and said tension mechanism comprises a spring, the tension in the spring being determined by the length of the cord.

73. A system as claimed in any of claim 72, in which said tension mechanism is adjustable and is employed to set the tension in the cord.

74. A system as claimed in claim 73, in which said adjustment mechanism comprises an extender, whereby the path length of the cord is adjustable to alter the tension of the cord.

75. A system as claimed in claim 58, further comprising:
first and second upper mounting components to mount said head assembly in said glazed aperture, each component including a mounting portion having at least one laterally extending planar finger configured to slide in use between the bead and the glazing pane; and
first and second connecting components configured operatively to attach the blind head assembly to the respective upper mounting components.

76. A system as claimed in claim 75, in which said upper mounting components further comprise a base portion having a base surface configured to rest in use against the glazing pane and a post portion configured to extend in use approximately orthogonally with respect to the plane of the glazing pane, wherein said base and post portions are retained by said mounting portion and said connecting components operatively attach the blind head assembly to the respective post portions of the upper mounting components.

77. A system for mounting a blind including a head assembly at a glazed aperture, the glazed aperture comprising a frame, a glass pane retained in the frame and a flexible or resilient bead disposed between the glass pane and the frame which bead bears against the glass pane; the system comprising:
first and second upper mounting components each including:
a base portion having a base surface configured to rest in use against the glass pane,
a post portion configured to extend in use approximately orthogonally with respect to the plane of the glass pane; and
a mounting portion having at least one laterally extending planar finger configured to slide in use between the bead and the glass pane; and
first and second connecting components configured operatively to attach the blind head assembly to the respective post formations.

78. A system as claimed in claim 77, wherein the mounting portions are adapted to be arranged in use at respective upper corners of the frame of the glazed aperture.

79. A system as claimed in claim 78, wherein the mounting portions each include first and second co-planar fingers arranged to extend orthogonally and configured to slide in use between the bead and the glass pane at adjacent sides of the frame.

80. A system as claimed in claim 77, wherein the respective upper mounting components are unitary.

81. A system as claimed in claim 77, wherein the first and second upper mounting components are non-unitary and respectively comprise:
first and second mounting formations each including a said base portion having a base surface configured to rest in use against the glass pane, and a said post portion configured to extend in use substantially orthogonally with respect to the plane of the glass pane; and
first and second mounting elements respectively constituting the mounting portions and each element comprising a first portion including attachment means by which the mounting element and post portion of the mounting formation are attached to each other and a second portion having said at least one laterally extending planar finger configured to slide in use between the bead and the glass pane.

82. A system as claimed in claim 81, wherein the attachment means comprise an aperture defined in the first portion of the mounting element through which aperture a respective post portion operatively passes.

83. A system as claimed in claim 82, wherein the respective post portions, apertures of the first portions and the base portions of the mounting formations are so sized and/or configured that the base portion cannot pass through the aperture.

84. A system as claimed in claim 77, wherein the connecting components each comprise a socket into which the post portion operatively slides for attachment of the blind head assembly to the respective post formations.

85. A system as claimed in claim 77, further comprising fixing means which co-operate with the respective connecting component and post portion to inhibit or prevent removal of the connecting component from the post portion.

86. A system as claimed in claim 77, further comprising at least first and second spacing elements of predetermined depth configured to be located in use respectively between the mounting portion and the connecting component.

87. A system as claimed in claim 81, further comprising at least first and second spacing elements of predetermined depth configured to be located in use respectively between the mounting element and the connecting component.

88. A system as claimed in claim 77, further comprising:
first and second longitudinally extensive side members configured to be mounted at the sides of the glazed window thereby to cover the bead and to extend from proximate the mounting portion to proximate the lowermost part of the glazed window; and
first and second retaining means adapted to retain respective the side members in position.

89. A system as claimed in claim 88, wherein the retaining means comprise first and second clips each including an engagement portion configured to engage the side member and a finger portion configured to slide in use between the bead and glass pane.

90. A system as claimed in claim 77, further comprising first and second lower mounting brackets each comprising a first portion having at least one laterally extending planar finger configured to slide in use between the bead and the glass pane, and a second portion configured for mounting an additional component.

91. A system as claimed in claim 90, wherein the second portion includes an attachment formation extending in use substantially orthogonally with respect to the plane of the glass pane.

92. A system as claimed in claim 91, further comprising a spacer mounted on the attachment formation.

93. A system as claimed in claim 89, further comprising first and second lower mounting brackets each comprising a first portion having at least one laterally extending planar finger configured to slide in use between the bead and the glass pane, and a second portion configured for mounting an additional component, and wherein lower end portions of the side members are, operatively, respectively in juxtaposition with the first and second lower mounting brackets.

94. A system as claimed in claim 89, further comprising first and second lower mounting brackets each comprising a first portion having at least one laterally extending planar finger configured to slide in use between the bead and the glass pane, and a second portion configured for mounting an additional component, and wherein the lower parts of the side members and the first and second lower mounting brackets respectively include operatively co-operating engagement formations.

95. A blind assembly for mounting at a glazed aperture of the type comprising a frame, a glazing pane retained in the frame and a flexible or resilient bead disposed between the glazing pane and the frame which bead bears against the glazing pane, the blind assembly comprising:
a blind head assembly from which a shade portion of the blind depends and including mounting means to mount the head assembly at the glazed aperture;
first and second lower mounting brackets, each comprising a first portion having at least a first laterally extending planar finger configured to slide in use between the bead and the glazing pane, and a second portion defining an attachment formation which extends substantially orthogonally with respect to the plane of the glazing pane; and
a support cord for connection to and extension from one attachment formation through one end of said slave bar into the head assembly and down through the other end of said slave bar to said other attachment formation.

96. A blind assembly as claimed in claim 95, in which the assembly further comprises:
first and second upper mounting components each including a mounting portion having at least one laterally extending planar finger for disposition between the bead and the glazing pane;
first and second connecting components by means of which the blind head assembly is attachable to the respective upper mounting components.

97. A blind assembly as claimed in claim 96, in which the mounting portions are adapted for arrangement at respective upper corners of the frame of the glazed aperture.

98. A blind assembly for mounting at a glazed aperture of the type comprising a frame, a glass pane retained in the frame and a flexible or resilient bead disposed between the glass pane and the frame which bead bears against the glass pane; the blind assembly comprising:
a blind head assembly from which a shade portion of the blind depends;
first and second upper mounting components each including:
a base portion having a base surface resting against the glass pane,
a post portion extending approximately orthogonally with respect to the plane of the glass pane; and
a mounting portion having at least one laterally extending planar finger disposed between the bead and the glass pane; and
first and second connecting components by means of which the blind head assembly is attached to the respective post formations.

99. A blind assembly as claimed in claim 98, wherein the mounting portions are arranged at respective upper corners of the frame of the glazed aperture.

100. A blind assembly as claimed in claim 99, wherein the mounting portions each include first and second co-planar fingers extending orthogonally and arranged between the bead and the glass pane at adjacent sides of the frame.

101. A blind assembly as claims in claim 100, wherein the respective upper mounting components are unitary.

102. A blind assembly as claimed in claim 100, wherein the first and second upper mounting components are non-unitary and respectively comprise:
first and second mounting formations each including a said base portion having a base surface resting against the glass pane, and a said post portion extending substantially orthogonally with respect to the plane of the glass pane; and
first and second mounting elements respectively constituting the mounting portions and each comprising a first portion including attachment means by which the mounting bracket and post portion of the mounting formation are attached and a second portion having said at least one laterally extending planar finger disposed between the bead and the glass pane.

103. A blind assembly as claimed in claim 102, wherein the attachment means comprise an aperture defined in the first portion of the mounting bracket through which aperture a respective post portion passes.

104. A blind assembly as claimed in claim 103, wherein the respective post portions, apertures of the first portions and the base portions of the mounting formations are so sized and/or configured that the base portion cannot pass through the aperture.

105. A blind assembly as claimed in claim 98, wherein the connecting components each comprise a socket within which the post portion is slidably engaged for attachment of the blind head assembly to the respective post formations.

106. A blind assembly as claimed in claim 98, further comprising fixing means which co-operate with the respective connecting component and post portion to prevent or inhibit removal of the connecting component from the post portion.

107. A blind assembly as claimed in claim 98, further comprising at least first and second spacing elements of predetermined depth arranged respectively between the mounting portion and the connecting component.

108. A blind assembly as claimed in claim 103, further comprising at least first and second spacing elements of predetermined depth arranged respectively between the mounting bracket and the connecting component.

109. A blind assembly as claimed in claim 98, further comprising:
first and second longitudinally extensive side members mounted at the sides of the glazed window thereby to cover the bead and extending from proximate the mounting bracket to proximate the lowermost part of the glazed window; and
first and second retaining means which retain respective the side members in position.

110. A blind assembly as claimed in claim 109, wherein the retaining means comprise first and second clips each including an engagement portion which engages the side member and a finger portion which slides between the bead and glass pane.

111. A blind assembly as claimed in claim 98, further comprising first and second lower mounting brackets each comprising a first portion having at least one laterally extending planar finger configured to slide in use between the bead and the glass pane, and a second portion configured for mounting an additional component.

112. A blind assembly as claimed in claim 111, wherein the second portion includes an attachment formation which extends substantially orthogonally with respect to the plane of the glass pane.

113. A blind assembly as claimed in claim 112, further comprising a spacer mounted on the attachment formation.

114. A blind assembly as claimed in claim 109, wherein lower end portions of the side members are respectively in juxtaposition with the first and second lower mounting brackets.

115. A blind assembly as claimed in claim 109, wherein the lower parts of the side members and the first and second lower mounting brackets respectively include co-operating engagement formations.

116. A method of mounting a blind at a glazed aperture, the blind comprising a head assembly, a blind panel attached to the head assembly and support cords to support the sides of the blind panel, and the glazed aperture comprising a frame, a glazing pane retained in the frame and a flexible or resilient bead disposed between the glazing pane and the frame which bead bears against the glazing pane; the method comprising:
mounting the head assembly to the glazed aperture;
providing a bottom anchor for said support cords, said anchor comprising first and second mounting elements, each comprising a first portion having at least a first laterally extending planar finger configured to slide in use between the bead and the glazing pane, and a second portion defining an attachment formation which extends substantially orthogonally with respect to the plane of the glazing pane, and connection means on said attachment formation for connection of said support cord for the blind at a distance from the glazing pane;
sliding the fingers of said first and second mounting elements between the glazing pane and the bead at bottom corners of the glazing pane;
attaching the cord to the attachment formations so that it is under tension between the anchor and the head assembly.

117. A method as claimed in claim 116, in which support clips are attached to the ends of said cord and said step of attaching the cord to the attachment formations comprises the step of connecting said support clips to said formations.

118. A method as claimed in claim 117, in which said connection of the support clips to said formations comprises moving said support clips in a direction orthogonal to the plane of said pane.

119. A method of mounting a blind including a head assembly at a glazed aperture, the glazed aperture comprising a frame, a glass pane retained in the frame and a flexible or resilient bead disposed between the glass pane and the frame which bead bears against the glass pane; the method comprising:
providing first and second mounting formations each including a base portion having a base surface and a post portion configured to extend in use approximately orthogonally with respect to the plane of the glass pane;
providing first and second mounting elements each comprising a first portion including attachment means and a second portion having at least one laterally extending finger; and
providing first and second connecting components attaching the respective mounting formations to the mounting brackets, placing the base surface of the base portions against the glass pane and sliding the fingers between the glass pane and the bead,
attaching the connecting components to respective side parts of the head assembly and mounting the respective connecting components on the post portions of the mounting formations.

120. A bottom anchor for a blind to be mounted at a glazed aperture, the blind being of the type including a head assembly from which extends one or more blind panels, and the glazed aperture comprising a frame, a glazing pane retained in the frame and a flexible or resilient bead disposed between the glazing pane and the frame which bead bears against the glazing pane,
said anchor comprising first and second mounting elements, each comprising a first portion having at least a first laterally extending planar finger configured to slide in use between the bead and the glazing pane, and a second portion defining an attachment formation which extends substantially orthogonally with respect to the plane of the glazing pane; and
connection means on said attachment formation for connection of a support cord for the blind at a distance from the glazing pane.

121. An anchor as claimed in claim 120, in which said second portion is configured for mounting a support clip comprising said attachment formation.

122. An anchor as claimed in claim 121, in which said support clip is a snap fit on said second portion.

123. An anchor as claimed in claim 120, in which said connection means comprises an eye to receive an end of said cord.
